(19) United States
(12) Patent Application Publication
(10) Pub. No.: US 2005/0216844 A1
(43) Pub. Date: Sep. 29, 2005

(54) Delayed transmission of website usage data

(76) Inventors: Brett M. Error, Orem, UT (US); Christopher Reid Error, Pleasant Grove, UT (US); Christopher Luby, Lehi, UT (US)

Correspondence Address: FENWICK & WEST LLP, SILICON VALLEY CENTER, 801 CALIFORNIA STREET, MOUNTAIN VIEW, CA, 94041, US

(21) Appl. No.: 10/795,079

(22) Filed: Mar. 3, 2004

(51) Int. Cl. G06F 3/00; G06F 17/21; G06F 15/16; G06F 15/173; G06F 9/44

(52) U.S. Cl. 715/745; 715/760; 715/513; 715/501.1; 709/203; 709/224; 709/219; 717/115

(57) ABSTRACT

User behavior on a website, including intra-page interactions, are tracked while avoiding the need to transmit each intra-page interaction to the data collection server via a separate request. Client-side code instructs the client to store intra-page interaction data in a local data store such as a cookie file. The client transmits the accumulated data to the data collection server in response to a triggering event. For example, data may be transmitted when a new page is loaded, or when the web browser application crashes or is terminated, or when the client machine is turned off, or at periodic intervals, or in response to any other type of triggering event.

### RELATED APPLICATIONS

This application claims priority from U.S. Provisional Application Ser. No. 60/452,085, dated Mar. 4, 2003, entitled “Delayed Data Collection Using Web Beacon-Based Tracking Methods,” (Attorney Docket No. 7652), the contents of which are incorporated by reference.

This application further claims priority from U.S. Provisional Application Ser. No. 60/452,084, dated Mar. 4, 2003, entitled “Associating Website Clicks with Links on a Web Page,” (Attorney Docket No. 7651), the contents of which are incorporated by reference.

This application is related to U.S. patent application Ser. No. 10/608,515 entitled “Efficient Click-Stream Data Collection” (Attorney Docket No. 7132), filed Jun. 26, 2003; U.S. patent application Ser. No. 10/608,442 entitled “Custom Event and Attribute Generation for Use in Website Traffic Data Collection” (Attorney Docket No. 7133), filed Jun. 26, 2003; U.S. patent application Ser. No. 10/609,008 entitled “Capturing and Presenting Site Visitation Path Data” (Attorney Docket No. 8054), filed Jun. 27, 2003; and U.S. patent application Ser. No. ______ entitled “Associating Website Clicks with Links On A Web Page” (Attorney Docket No. 7762), filed on the same date as the present application. The contents of these related patent applications are incorporated herein by reference.

### FIELD OF THE INVENTION

The present invention is related to tracking website usage, and more particularly to locally storing data describing website usage to enable delayed transmission of the website usage data.

### DESCRIPTION OF THE BACKGROUND ART

In an on-line environment, website usage and other customer behavior may be tracked by a website server, or by another server such as a data collection server (also known as a data collector), which may be remotely located. The data collection server is notified of activity on a website so that it can monitor and track the activity. One method of achieving this notification is through the use of a request for embedded content.

Embedded content is part of a web page, such as an image, that is requested as a separate file from the file containing the web page. The separate file may be requested from the website server or from a remote server, such as a remote content server or data collection server. For example, when a user requests a web page from a website server, the website server sends the web page file to the user's client. The client, such as a web browser, then attempts to render the file as a viewable web page. However, upon rendering the web page file, the client may find a reference to a separate file located on the website server or a remote server. After the content is located and sent to the client, the client renders the separate file containing the embedded content along with the original web page.

A web beacon (also known as a web bug) is a particular type of embedded content where the content itself is irrelevant, but the request for content carries useful information. For example, a web beacon is often a transparent image having very small dimensions, such as 1 pixel by 1 pixel. This image is small enough to be invisible to the user. When a client is rendering a web page that includes a web beacon, the web beacon causes the client to send a resource request to a server such as a data collection server. The web beacon may include a script (or other code) that causes the client to include, in the resource request, additional information about the user and the user's environment. The additional information can include the data from a cookie, or other information about the client's operating environment or status. Where the server indicated by the web beacon code is a data collection server, the data collection server may, in response to the request, cause the client to set an additional cookie for identification for tracking purposes. In this manner, the web beacon request can be used to indicate to a data collection server that a particular web page is being rendered.

One method for including the request is to write the request as a static image tag in Hypertext Markup Language (HTML). The following is an example of an image tag in HTML:
<img src=“http://ad.datacollectionserver.com/tracker.exe?AID=14658&PID=259294& banner=0.gif” width=1 height=1 border=0>

Here, the term “ad.datacollectionserver.com” refers to the address of the data collection server.

Another common method of including the request is to use a scripting language such as JavaScript so as to cause the browser to dynamically generate a request to the data collection server. One advantage of using a script instead of a static image tag is that the script can perform other functions including gathering additional data and sending it along with the request. In either case, the result is a request sent to the data collection server upon the occurrence of an event, such as the loading and rendering of a web page.

Once the request has been sent to the data collection server, the data collection server can perform various types of tracking functions. For example, the data collection server can count the number of requests so as to monitor traffic on the web page. By counting the number of times the web beacon element has been requested from the data collection server, the server can determine the number of times a particular page was viewed. By using JavaScript to dynamically construct the request for the web beacon and encode additional information, other identifying information can be obtained for further analysis.

It is often desirable to track intra-page interactions as well as page views. Intra-page interactions are actions performed by the user while viewing a document such as a web page. For example, a user may click within a specified area of the screen, or cause the cursor to move to or hover over a particular element or area of the screen; such actions may or may not cause a new page to be loaded. Some prior art systems track such intra-page interactions by requesting web beacons via a background process in response to certain intra-page interaction events. For example, a web beacon request might be generated each time the cursor passes over a particular element.

FIG. 2 depicts an example of such a technique for tracking intra-page interactions according to a prior art method. When the user requests page A, a request describing the page load is sent to a data collection server. For each intra-page interaction that is performed with respect to page A, a new request describing the interaction is sent. Similarly, individual requests are sent for interactions taking place with respect to page B (as well as a request describing the page load of page B). For each action and each page load, a separate request is sent to the server. Such repeated generation of web beacon requests is inefficient and time-consuming, and it can result in undesirably slow performance and responsiveness.

What is needed is a technique for enabling such detailed usage tracking, while avoiding or reducing any reduction in perceived performance and responsiveness. What is further needed is a technique for intra-page interaction tracking that reduces or eliminates the need to make a new request for each event. What is further needed is a technique for usage tracking that reduces costs by reducing the number of requests generated in transmitting website usage data. What is further needed is a technique that avoids the limitations and shortcomings of prior art user behavior tracking methodologies.

### SUMMARY OF THE INVENTION

According to the techniques of the present invention, interactions are tracked while avoiding the need to transmit each interaction to the data collection server via a separate request. Instead, client-side code (such as JavaScript) instructs the client to store the interaction data in a local data store. For example, a description of each interaction may be locally stored in a cookie file. In one embodiment, the invention is used for transmitting descriptions of intra-page interactions; in another embodiment, it is used for transmitting interpage or other types of interactions.

In one embodiment, the present invention operates in the context of a browser for displaying web pages at a client machine. The format of the locally stored data may vary depending on the type of data being collected, and any number of cookies (or other types of local data stores) may be used. When multiple cookies are used, the data may be split among the cookies in any fashion appropriate to collection. Alternatively, any other local data store available to the client can be used.

The client transmits the accumulated data to the data collection server in response to a triggering event. For example, data may be transmitted when a new page is loaded, or when the browser application crashes or is terminated, or when the client machine is turned off, or at periodic intervals, or in response to any other type of triggering event.

In one embodiment, when a new page is loaded, the client transmits information to the data collection server to describe the page view being loaded as well as accumulated information about intra-page interactions that occurred previous to the page view being loaded. The data collection server receives the data, and separates it into two components: data about the current page view; and accumulated data contained in the local data store from previous activity. Once transmitted to the server, the data is cleared from the local data store, so as to reset the buffer for additional information.

In this way, the invention locally stores data describing intra-page interaction, so that the accumulated data can be transmitted to the data collection server more efficiently. In particular, the invention avoids the need to open a new connection with the data collection server, or to transmit a new request to the data collection server, each time an intra-page interaction takes place.

### BRIEF DESCRIPTION OF THE DRAWINGS

FIG. 1 is a block diagram depicting a system for delayed transmission of website usage data according to one embodiment of the present invention.

FIG. 2 is a block diagram depicting an example of tracking intra-page interactions according to the prior art.

FIG. 3 is a block diagram depicting an example of tracking intra-page interactions according to one embodiment of the present invention.

FIG. 4 is a flow chart depicting a method for tracking intra-page interactions according to one embodiment of the present invention.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DESCRIPTION OF AN EMBODIMENT OF THE INVENTION

In the following description, the term “intra-page interaction” is used to refer to any type of detectable activity or action performed by the user while viewing a document such as a web page. Examples of intra-page activity include, without limitation:
passing the mouse over a link on the page
moving the mouse around the document
clicking on a hyperlink
clicking on or changing the value of a form field
submitting a form
scrolling
clicking on a check box, radio button, or other element of the page
selecting text, drawing, or other object on the page
starting, stopping, or pausing video or audio playback
activating keyboard-based commands
and the like.

Some of these actions cause a new page to be loaded. In such cases, in one embodiment intra-page interaction is considered to include everything that takes place in response to such an action until the new page is actually requested. For example, clicking on a hyperlink generates an “onClick” event in the document, which can be captured by JavaScript and is considered to be intra-page interaction. After handling the onClick event, the browser requests the document to which the link points, leading to a new page load. Similarly, when closing the browser or moving to another page the “onUnload” event is generated before moving on or closing the browser; this onUnload event is also considered to be an intra-page interaction.

In the following description, the invention is set forth in terms of tracking intra-page interactions. However, one skilled in the art will recognize that the techniques of the invention can be used for tracking intra-page, interpage, or other types of interactions.

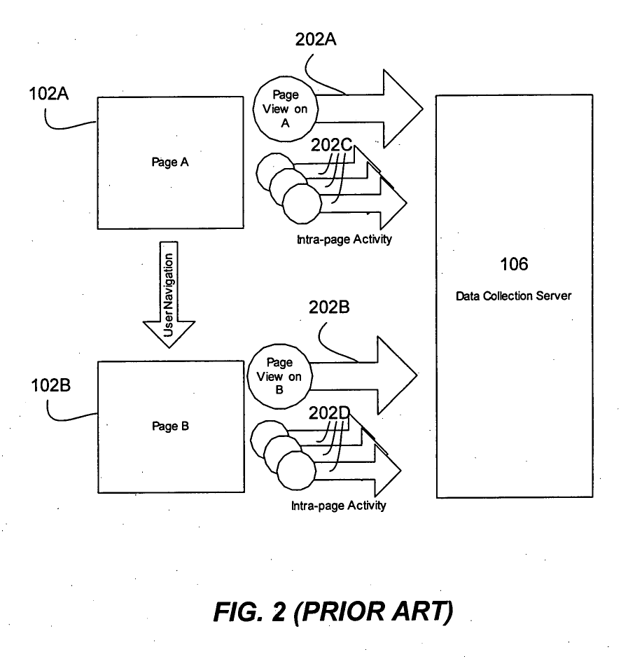

As described above, FIG. 2 depicts an example of tracking intra-page interactions according to a prior art method. When the user requests page A 102A, request 202A describing the page load is sent to data collection server 106. For each intra-page interaction that is performed with respect to page A, a new request 202C describing the interaction is sent to server 106. Similarly, individual requests 202D are sent for interactions taking place with respect to page B 102B (as well as request 202B describing the page load of page B 102B). Each action is transmitted to data collection server 106 independently. Thus, for the example shown wherein two pages 102A, 102B are visited and wherein three intra-page interactions are performed on each page, a total of eight requests 202A, 202B, 202C, 202D are transmitted to server 106.

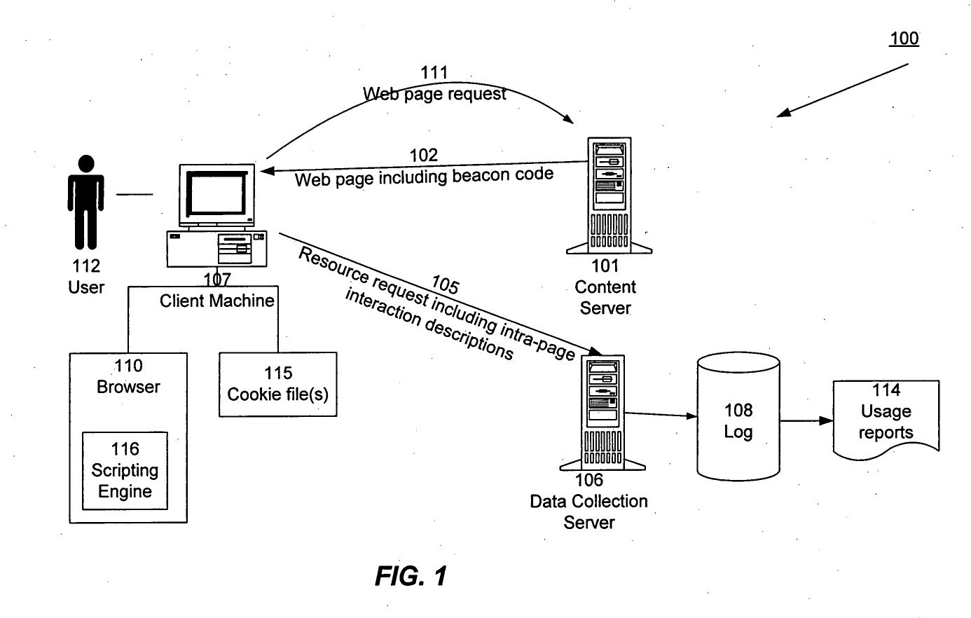

Referring now to FIG. 1, there is shown a block diagram depicting a system for delayed transmission of website usage data according to one embodiment of the present invention. User 112 interacts with client machine 107, which runs a software application such as browser 110 for accessing and displaying web pages. Client machine 107 may be an ordinary personal computer, including well-known components such as a CPU running an operating system such as Microsoft Windows, a keyboard, mouse, display screen, and Internet connection (not shown). Client machine 107 may run various software applications in addition to browser 110. Browser 110 includes scripting engine 116, such as JavaScript, as is commonly found in commercially available browsers. In response to a user 112 action such as clicking on a link or typing in a URL, client machine 107 issues a web page request 111 that is transmitted via the Internet to content server 101. In response to request 111, content server 101 transmits web page 102 (in the form of HTML code, for example) to client machine 107. Browser 110 displays the requested web page 102 on client machine 107.

Web page 102 includes beacon code, which in one embodiment is a pointer to a beacon (such as a 1 pixel by 1 pixel transparent image). The beacon is typically invisible to the user, such as a transparent one-pixel image. The beacon code can be provided as a script to be executed by scripting engine 116. The beacon code causes client machine 107 to generate resource requests 105 to data collection server 106. Data collection server 106 records such requests in a log 108, and can also record additional information associated with the request (such as the date and time, and possibly some identifying information that may be encoded in the resource request). Thus, data collection server 106 records the occurrence of a “hit” to web page 102. Data collection server 106 also transmits the requested one-pixel image to client machine 107 so that the resource request is satisfied.

While user 112 is viewing page 102, he or she may perform any number of intra-page interactions. Rather than generate and transmit separate resource requests to server 106 for each such interaction, the beacon code causes client machine 107 to store descriptions of such intra-page interactions locally. Any type of local storage mechanism can be used, such as for example a cookie file 115. In one embodiment, each intra-page interaction is stored in a separate cookie file 115; in another embodiment, a single cookie file 115 is initiated for the first intra-page interaction on web page 102, and subsequent intra-page interactions are appended to the existing cookie file 115.

Upon occurrence of a triggering event, client machine 107 transmits, to server 106, a resource request 105 including the intra-page interaction descriptions that have been locally stored. In one embodiment, once the intra-page interaction descriptions have been transmitted, they are deleted from local storage. In another embodiment, client machine 107 awaits an acknowledgment from server 106 that the data was received, and deletes the descriptions from local storage in response to such an acknowledgment. In another embodiment, locally stored descriptions are retained and/or archived.

One such triggering event is a page load. Thus, when a new web page 102 is requested, client machine 107 transmits a description of the new page load along with accumulated intra-page interaction descriptions for the “old” page. In one embodiment, a single request 105 contains both the new page load description and the intra-page interaction descriptions.

In other embodiments, other types of events can trigger transmission of the intra-page interaction descriptions. For example, a request 105 including the descriptions can be transmitted periodically based on some predetermined time period, or once a certain amount of data has been accumulated, or in response to any or all of the following: the user terminating the browser 110 application; shutdown of client machine 107; loss of a network connection; reestablishment of a network connection; startup after unexpected shutdown (such as from a power loss) or after a crash; explicit directive from the user; explicit directive from content server 101 or data collection server 106 or some other entity; or the like. One skilled in the art will recognize that many other types of triggering events can be used in connection with the present invention without departing from its essential characteristics.

In one embodiment, communications between client machine 107, content server 101, and data collection server 106 are accomplished using well known network protocols, such as TCP/IP and HTTP, for communication across the Internet. Other communication methodologies and protocols can also be used.

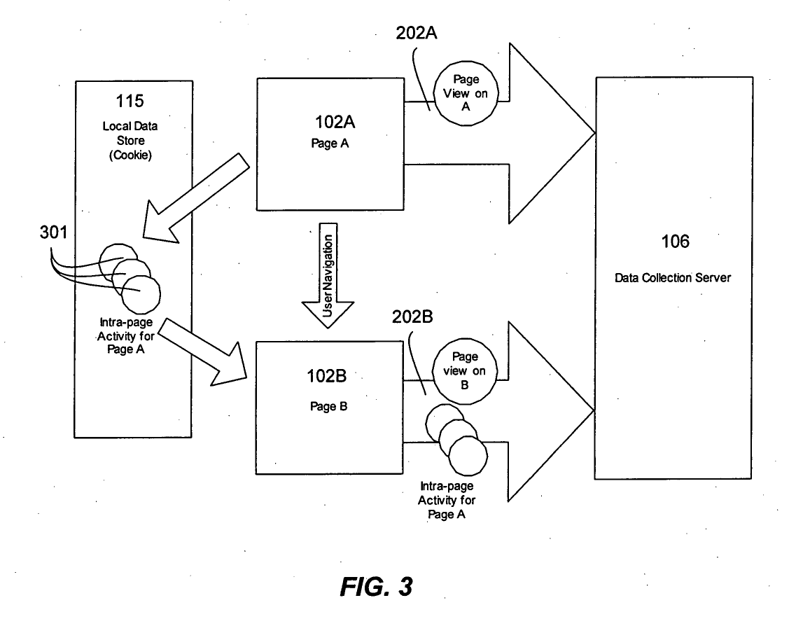

Referring now to FIG. 3, there is shown a block diagram depicting an example of tracking intra-page interactions according to one embodiment of the present invention.

Page 102A is displayed, and request 202A is transmitted to server 106 containing a description of the page load. While the user is viewing page 102A, he or she performs various intra-page interactions. Descriptions 301 of these interactions are stored in local data store such as cookie file 115. When the user navigates to page 102B, request 202B is transmitted, containing a description of the page 102B along with descriptions 301 of the intra-page interactions from page 102A.

In one embodiment, the generation and transmission of requests to server 106 are performed by browser 110 in response to scripting commands from the beacon code embedded in web pages 102. Specifically, in one embodiment the beacon code is provided in JavaScript or some other client-side script language, and JavaScript (or other scripting) engine 116 performs the generation and transmission of requests to server 106.

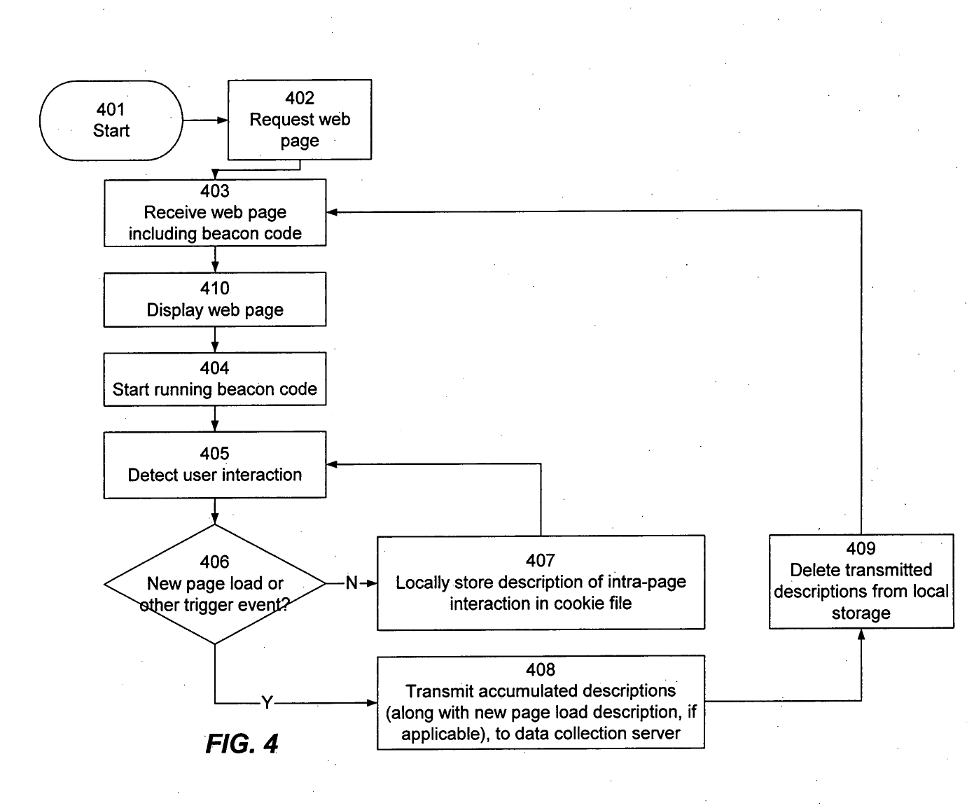

Referring now to FIG. 4, there is shown a flow chart depicting a method for tracking intra-page interactions according to one embodiment of the present invention. The user requests 402 a web page 102. Client machine 107 receives web page 102 including beacon code, and displays 410 it. As web page 102 is displayed, beacon code runs 404; this is code that was embedded in web page 403 and is capable of being executed by scripting engine 116 in browser 110.

When a user action is detected 405, client machine 107 determines 406 whether the action is a new page load (or whether some other trigger event has taken place). If no trigger event has taken place, and if the new action is not a new page load, then the action is an intra-page interaction. Client machine 107 locally stores 407 a description of the interaction in cookie file 115, and returns to step 405.

If, in 406, the action is a new page load, or if a trigger event is detected, client machine 107 generates and transmits 408 a request 105 to data collection server 106, including the accumulated locally stored descriptions of intra-page interactions. As described above, this request 105 can also include a description of the new page load, if appropriate. In one embodiment, client machine 107 performs step 408 under the direction of new beacon code from the new web page; thus step 403 would be performed (for the new web page) before step 408.

One skilled in the art will recognize that some triggering events are not related to user interactions. Thus, in some situations client machine 107 performs step 408 without having detected 405 a new user interaction, in response to a triggering event taking place.

In one embodiment, once client machine 107 has transmitted locally stored descriptions, it deletes 409 the descriptions from local storage. As described above, in another embodiment client machine 107 awaits an acknowledgment from server 106 before deleting locally stored descriptions. In yet another embodiment, locally stored descriptions are retained and/or archived.

In some cases, after descriptions have been stored locally, the user may close the browser or move on to a page that does not include a web beacon. In one embodiment, in such a situation the locally stored descriptions are simply deleted or allowed to expire. In another embodiment, the locally stored descriptions are retained until the next time the user does request another page containing an appropriate web beacon, either in the current web session or in some future session; at that time, the descriptions are transmitted as part of a resource request as described above. In another embodiment, in such a situation client machine 107 checks to see if the next page being requested is within the current domain. If it is, client machine 107 assumes that there will be web beacon code on this page and it does nothing further (since the new beacon code will contain appropriate instructions that will result in the locally stored descriptions being sent). If the page being requested is not within the current domain, client machine 107 initiates a special request to data collection server 106 to transmit the locally stored information before moving on to the next page.

The present invention can be used to capture many different types of interactions. For example, it may be desirable to track mouse movements across a web page 102. Accordingly, in one embodiment a client-side script timer (not shown) collects the coordinates of the mouse every few seconds and stores them in a local data store such as cookie file 115. When the user indicates that he or she wishes to move to another page 102, or closes browser 110, client machine 107 initiates a connection to data collection server 106 and transmits a request including the collected mouse coordinates. In one embodiment this operation is performed under the direction of web beacon code on the newly requested page 102; in another embodiment the operation is performed under the direction of special code detecting the user action or other trigger event.

The invention is described herein in the context of tracking intra-page interactions on a website. However, one skilled in the art will recognize that the invention can also be used to capture other types of data, and that it can further be adapted to collect data at different frequencies. For example, it may be determined to be advantageous to pass in the name of the page being viewed only once for every five pages viewed. Using the techniques of the present invention, client machine 107 can locally store the name of the page 102 being viewed each time a page 102 is accessed. Once the number of pages 102 in the local store exceeds five (or whatever threshold number is appropriate), client machine 107 initiates a connection to data collection server 106 and transmits a request including the accumulated data.

Other trigger events can also be used to initiate transmission of data, such as for example clicking on a particular link or visiting a particular page. In particular, when a website spans multiple domains, such an approach is helpful to avoid inherent limitations in cookie use. In general, a cookie is only available on the domain that created the cookie. Thus, in order to avoid data loss when moving from one domain to another, in one embodiment client machine 107 identifies links that point to a domain different from the current domain. In response to a user clicking on such a link, client machine 107 initiates a connection to data collection server 106 and transmits a request including the accumulated data before the new domain is entered.

In another embodiment, client machine 107 detects actions that will result in the browser being closed or terminated. If the user closes the browser before locally stored data has been sent to server 106, the impending close operation is detected so that data from the local store can be transmitted. For example, client machine 107 might delay the close of the browser for a few milliseconds while it transmits the locally stored data.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer, network of computers, or other apparatus. Various general-purpose systems may be used with programs in accordance with the teachings herein, or it may prove convenient to construct a more specialized apparatus to perform the required method steps. The required structure for a variety of these systems appears from the description. In addition, the present invention is not described with reference to any particular programming language. It will be appreciated that a variety of programming languages may be used to implement the teachings of the invention as described herein.

As will be understood by those familiar with the art, the invention may be embodied in other specific forms without departing from the spirit or essential characteristics thereof. For example, the particular architectures depicted above are merely exemplary of one implementation of the present invention. The functional elements and method steps described above are provided as illustrative examples of one technique for implementing the invention; one skilled in the art will recognize that many other implementations are possible without departing from the present invention as recited in the claims. Likewise, the particular capitalization or naming of the modules, protocols, features, attributes, or any other aspect is not mandatory or significant, and the mechanisms that implement the invention or its features may have different names or formats. In addition, the present invention may be implemented as a method, process, user interface, computer program product, system, apparatus, or any combination thereof. Accordingly, the disclosure of the present invention is intended to be illustrative, but not limiting, of the scope of the invention, which is set forth in the following claims.

1. A method of collecting and transmitting data describing user behavior on a web page, comprising:
displaying the web page;
detecting a first event;
locally storing, at a client, a description of the first event;
detecting a second event;
locally storing, at the client, a description of the second event;
responsive to a third event, transmitting to a data collection server, the descriptions of the first and second events.

2. The method of claim 1, wherein:
locally storing a description of the first event comprises storing the description in a cookie file; and
locally storing a description of the second event comprises storing the description in the cookie file.

3. The method of claim 1, wherein:
locally storing a description of the first event comprises storing the description in a cookie file; and
locally storing a description of the second event comprises appending the description to the cookie file.

4. The method of claim 1, wherein:
locally storing a description of the first event comprises storing the description in a first cookie file; and
locally storing a description of the second event comprises storing the description in a second cookie file.

5. The method of claim 1, wherein:
detecting a first event comprises detecting a first user action with respect to an element of the web page; and
detecting a second event comprises detecting a second user action with respect to an element of the web page.

6. The method of claim 1, wherein:
detecting a first event comprises detecting a first intra-page interaction; and
detecting a second event comprises detecting a second intra-page interaction.

7. The method of claim 1, wherein:
at least one of the first and second events comprises a cursor movement.

8. The method of claim 1, wherein the third event comprises a request for a new web page.

9. The method of claim 1, wherein the web page is associated with a first domain, and wherein the third event comprises a request for a web page associated with a second domain.

10. The method of claim 1, wherein the third event comprises expiry of a predetermined period of time.

11. The method of claim 1, wherein the third event comprises at least one selected from the group consisting of:
termination of a client application;
shutdown of the client;
explicit user command;
explicit directive received from the server;
explicit directive received from another source;
launch of a client application after it has been previously terminated;
re-establishment of a network connection following a loss; and
re-establishment of power following an outage.

12. The method of claim 1, further comprising repeating the detecting and storing steps until the third event is detected.

13. The method of claim 1, wherein the third event comprises storage of a predetermined number of event descriptions.

14. The method of claim 1, further comprising:
responsive to the third event, deleting the locally stored descriptions of the first and second events.

15. The method of claim 1, further comprising:
responsive to an indication that the transmitted descriptions have been received, deleting the locally stored descriptions of the first and second events.

16. A method of collecting and transmitting data describing user behavior on a web page, comprising:
displaying the web page;
detecting a first event;
locally storing, at a client, a description of the first event;
responsive to a second event, transmitting to a data collection server, the description of the first event.

17. The method of claim 16, wherein:
locally storing a description of the first event comprises storing the description in a cookie file.

18. The method of claim 16, wherein:
detecting a first event comprises detecting an intra-page interaction.

19. The method of claim 16, wherein the second event comprises a request for a new web page.

20. A method of collecting and transmitting data describing user behavior on a web page, comprising:
displaying the web page;
periodically performing the steps of:
collecting coordinates for an on-screen cursor; and
locally storing the coordinates at a client; and
responsive to a trigger event, transmitting to a data collection server, the stored coordinates.

21. The method of claim 20, wherein:
locally storing the coordinates comprises storing the coordinates in a cookie file.

22. The method of claim 20, wherein the trigger event comprises a request for a new web page.

23. A computer program product for collecting and transmitting data describing user behavior on a web page, comprising:
a computer-readable medium; and
computer program code, encoded on the medium, for:
displaying the web page;
detecting a first event;
locally storing, at a client, a description of the first event;
detecting a second event;
locally storing, at the client, a description of the second event;
responsive to a third event, transmitting to a data collection server, the descriptions of the first and second events.

24. The computer program product of claim 23, wherein:
the computer program code for locally storing a description of the first event comprises computer program code for storing the description in a cookie file; and
the computer program code for locally storing a description of the second event comprises computer program code for storing the description in the cookie file.

25. The computer program product of claim 23, wherein:
the computer program code for locally storing a description of the first event comprises computer program code for storing the description in a cookie file; and
the computer program code for locally storing a description of the second event comprises computer program code for appending the description to the cookie file.

26. The computer program product of claim 23, wherein:
the computer program code for locally storing a description of the first event comprises computer program code for storing the description in a first cookie file; and
the computer program code for locally storing a description of the second event comprises computer program code for storing the description in a second cookie file.

27. The computer program product of claim 23, wherein:
the computer program code for detecting a first event comprises computer program code for detecting a first user action with respect to an element of the web page; and
the computer program code for detecting a second event comprises computer program code for detecting a second user action with respect to an element of the web page.

28. The computer program product of claim 23, wherein:
the computer program code for detecting a first event comprises computer program code for detecting a first intra-page interaction; and
the computer program code for detecting a second event comprises computer program code for detecting a second intra-page interaction.

29. The computer program product of claim 23, wherein:
at least one of the first and second events comprises a cursor movement.

30. The computer program product of claim 23, wherein the third event comprises a request for a new web page.

31. The computer program product of claim 23, wherein the web page is associated with a first domain, and wherein the third event comprises a request for a web page associated with a second domain.

32. The computer program product of claim 23, wherein the third event comprises expiry of a predetermined period of time.

33. The computer program product of claim 23, wherein the third event comprises at least one selected from the group consisting of:
termination of a client application;
shutdown of the client;
explicit user command;
explicit directive received from the server;
explicit directive received from another source;
launch of a client application after it has been previously terminated;
re-establishment of a network connection following a loss; and
re-establishment of power following an outage.

34. The computer program product of claim 23, further comprising computer program code for repeating the detecting and storing steps until the third event is detected.

35. The computer program product of claim 23, wherein the third event comprises storage of a predetermined number of event descriptions.

36. The computer program product of claim 23, further comprising computer program code, encoded on the medium, for:
responsive to the third event, deleting the locally stored descriptions of the first and second events.

37. The computer program product of claim 23, further comprising computer program code, encoded on the medium, for:
responsive to an indication that the transmitted descriptions have been received, deleting the locally stored descriptions of the first and second events.

38. A computer program product for collecting and transmitting data describing user behavior on a web page, comprising:
a computer-readable medium; and
computer program code, encoded on the medium, for:
displaying the web page;
detecting a first event;
locally storing, at a client, a description of the first event;
responsive to a second event, transmitting to a data collection server, the description of the first event.

39. The computer program product of claim 38, wherein:
the computer program code for locally storing a description of the first event comprises computer program code for storing the description in a cookie file.

40. The computer program product of claim 38, wherein:
the computer program code for detecting a first event comprises computer program code for detecting an intra-page interaction.

41. The computer program product of claim 38, wherein the second event comprises a request for a new web page.

42. A computer program product for collecting and transmitting data describing user behavior on a web page, comprising:
a computer-readable medium; and
computer program code, encoded on the medium, for:
displaying the web page;
periodically performing the steps of:
collecting coordinates for an on-screen cursor; and
locally storing the coordinates at a client; and
responsive to a trigger event, transmitting to a data collection server, the stored coordinates.

43. The computer program product of claim 42, wherein:
the computer program code for locally storing the coordinates comprises computer program code for storing the coordinates in a cookie file.

44. The computer program product of claim 42, wherein the trigger event comprises a request for a new web page.

45. A system for collecting and transmitting data describing user behavior on a web page, comprising:
a display screen, for displaying the web page;
a user input device, for detecting a first event and for detecting a second event;
a client-based storage device, coupled to the user input device, for locally storing a description of the first event and for locally storing a description of the second event;
a network interface, coupled to the storage device, for responsive to a third event, transmitting to a data collection server, the descriptions of the first and second events.

46. The system of claim 45, wherein the client-based storage device comprises a cookie file.

47. The system of claim 45, wherein:
the first event comprises a first intra-page interaction; and
the second event comprises a second intra-page interaction.

48. The system of claim 45, wherein:
at least one of the first and second events comprises a cursor movement.

49. The system of claim 45, wherein the third event comprises a request for a new web page.

50. The system of claim 45, wherein the web page is associated with a first domain, and wherein the third event comprises a request for a web page associated with a second domain.

51. The system of claim 45, wherein the third event comprises expiry of a predetermined period of time.

52. The system of claim 45, wherein the third event comprises at least one selected from the group consisting of:
termination of a client application;
shutdown of the client;
explicit user command;
explicit directive received from the server;
explicit directive received from another source;
launch of a client application after it has been previously terminated;
re-establishment of a network connection following a loss; and
re-establishment of power following an outage.

53. The system of claim 45, wherein the user input device continues to detect events and the storage device continues to store descriptions of the events the third event is detected.

54. The system of claim 45, wherein the third event comprises storage of a predetermined number of event descriptions.

55. The system of claim 45, wherein:
responsive to the third event, the storage device deletes the locally stored descriptions of the first and second events.

56. The system of claim 45, wherein:
responsive to an indication that the transmitted descriptions have been received, the storage device deletes the locally stored descriptions of the first and second events.

57. A system for collecting and transmitting data describing user behavior on a web page, comprising:
a display screen, for displaying the web page;
a user input device, for detecting a first event;
a client-based storage device, coupled to the user input device, for locally storing a description of the first event;
a network interface, coupled to the storage device, for responsive to a second event, transmitting to a data collection server, the description of the first event.

58. The system of claim 57, wherein the client-based storage device comprises a cookie file.

59. The system of claim 57, wherein:
the first event comprises an intra-page interaction.

60. The system of claim 57, wherein the second event comprises a request for a new web page.

61. A system for collecting and transmitting data describing user behavior on a web page, comprising:
a display screen, for displaying the web page;
a user input device, for periodically collecting coordinates for an on-screen cursor;
a client-based storage device, coupled to the user input device, for locally storing the coordinates; and
a network interface, coupled to the storage device, for responsive to a trigger event, transmitting to a data collection server, the stored coordinates.

62. The system of claim 61, wherein the storage device comprises a cookie file.

63. The system of claim 61, wherein the trigger event comprises a request for a new web page.
